(19) United States
(12) Patent Application Publication
(10) Pub. No.: US 2025/0038382 A1
(43) Pub. Date: Jan. 30, 2025

(54) METHOD FOR FILLING A CAVITY

(71) Applicant: Atlas Copco IAS GmbH, Bretten (DE)

(72) Inventors: Gerrit ENDERLE, Knittlingen (DE); Thomas HAUSNER, Bretten (DE); Frederic HEMMANN, Karlsruhe (DE)

(73) Assignee: Atlas Copco IAS GmbH, Bretten (DE)

(21) Appl. No.: 18/715,245

(22) PCT Filed: Oct. 18, 2022
(86) PCT No.: PCT/EP2022/078975

§ 371 Date: May 31, 2024

(30) Foreign Application Priority Data
Dec. 2, 2021 (DE) 10 2021 131 798.3

(51) Int. Cl. H01M 50/618; H01M 10/653; H01M 50/636

(52) U.S. Cl. CPC H01M 50/618; H01M 10/653; H01M 50/636

(57) ABSTRACT

A method for filling a cavity, in particular a cavity in a battery arrangement, includes a battery tray and a battery accommodated in the battery tray, with a viscous material, in particular a thermal paste. The cavity is evacuated before the viscous material is introduced. The evacuation of the cavity may take place at at least one evacuation opening.

The invention relates to a method for filling a cavity, in accordance with the preamble of claim 1.

Such methods are used, in particular, in the motor vehicle industry, if a cavity in a battery arrangement is filled with a viscous material, in particular with a heat-conductive paste. In this regard, the battery arrangement has a battery tray and a battery accommodated in the battery tray. In this regard, a cavity between the battery and the battery tray is regularly filled with a heat-conductive paste, so that heat that occurs when the battery is being charged can be well conducted away out of the battery arrangement. In the case of known methods, however, it is often problematic that for one thing, the volume of the cavity is not precisely known due to production tolerances of the battery and/or of the battery tray. If too much heat-conductive paste is introduced into the cavity, it can damage the battery tray and/or the battery. If too little heat-conductive paste is introduced, then heat dissipation is not sufficient. For another thing, it can also be problematic that air situated in the cavity must be displaced during introduction of the heat-conductive paste, so that here, further resistance to introduction of the heat-conductive paste exists.

It is therefore the task of the invention to further develop a method of the type stated initially, in such a manner that the cavity can be filled with the viscous material more reliably.

This task is accomplished, according to the invention, by means of a method having the characteristics of claim 1. Advantageous further developments of the invention are the object of the dependent claims.

The invention is based, for one thing, on the recognition that the introduction of the viscous material is facilitated if the cavity is evacuated before the introduction. In this regard, it is practical if the evacuation takes place at at least one evacuation opening. In this regard, it is preferred that each evacuation opening is closed off by means of an air-permeable covering element, so that the viscous material that is introduced cannot exit from it again, or can exit only in small amounts.

It is practical if the at least one covering element is produced from a nonwoven fabric or from a selectively permeable membrane. It preferably has a thickness of at least 0.5 mm and at most 3mm, and preferably of 1 mm to 2 mm. Depending on the viscous material that is introduced, it is practical if the covering element is selected in such a manner that it has a selective permeability for the viscous material, which amounts to at most 1/20 of the permeability for air, wherein this value is preferably related to mass.

It is practical if the introduction of the viscous material takes place at at least one filling opening. In this regard, it is preferred that each filling opening is arranged at a distance from each of the evacuation openings. In order to prevent the viscous material from exiting from the filling opening again, it is practical if a sealing element is arranged at every filling opening, which element opens into the cavity if an excess pressure is present outside of the cavity, and closes if an excess pressure is present in the cavity; this element can have a slit plastic film, for example. It is preferred if the vacuum in the cavity is maintained until the end of the introduction of the viscous material. This can take place by means of closing the evacuation opening(s) or, alternatively, by means of continued evacuation.

For another thing, evacuation of the cavity allows measuring the amount of air evacuated from the cavity, so that the volume of the cavity can be calculated. This advantageous further development of the method according to the invention is based on the idea that an amount of viscous material can be introduced into the cavity, the volume of which material corresponds to the calculated volume of the cavity. The amount of the introduced viscous material can then be metered more precisely. In this regard, it is practical if the amount of air evacuated from the cavity is measured by means of a through-flow measurement device or by means of a piston metering device. Both are proven and precise measuring devices that are available on the market. According to a further development of the method according to the invention, the pressure in the cavity is measured, and at least the pressure prevailing in the evacuated cavity is used to calculate the volume of the cavity. It is then not necessary to proceed from a perfect vacuum after evacuation, by approximation, but rather it is possible to draw a conclusion regarding the remaining residual amount of air in the cavity from the pressure prevailing in the cavity after evacuation.

Likewise, the pressure prevailing in the cavity before evacuation can be used to calculate the volume of the cavity, so that here, too, it is not necessary to proceed from the atmospheric pressure by approximation. Furthermore, it can be provided that the pressure in the cavity is measured by means of a pressure sensor arranged in the feed line for the viscous material, and that the introduction of the viscous material is stopped when the measured pressure exceeds a predetermined reference value. Exceeding the reference value can be used as a shut-off criterion of equal rank, higher rank or lower rank as compared with the shut-off criterion of the introduction of the calculated volume of viscous material.

In the following, the invention will be explained in greater detail using an exemplary embodiment that is shown schematically in the drawing. The drawing shows

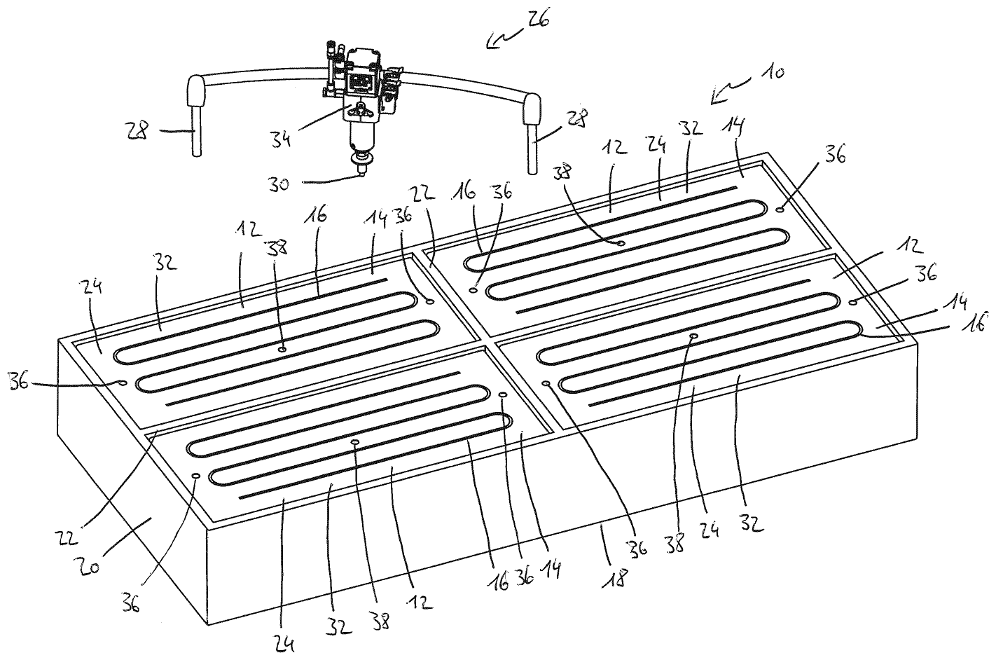

FIG. 1 a battery box having four battery arrangements, as well as a filling device.

The battery box 10 shown in FIG. 1 has four battery arrangements 12 that each have a battery 16, shown only schematically here, which is accommodated in a battery tray 14. In this regard, the battery trays 14 are configured cohesively, with a common bottom 18, a common circumferential side wall 20, as well as inner partition walls 22. In each battery arrangement 12, there is a cavity 24 between the battery tray 14 and the battery 16 accommodated in it, which cavity must be filled with a heat-conductive paste. A filling device 26 is provided for introducing the heat-conductive paste, which device has two ventilation nozzles 28 as well as a filling nozzle 30. The ventilation nozzles 28 are connected with a vacuum pump, a Venturi jet or a similar device, to produce a vacuum, by way of a through-flow measurement device that is not shown in any detail. The filling nozzle 30 is connected with a metering device 34 for the heat-conductive paste.

Each of the battery trays 14 has a ceiling wall 32 having two evacuation openings 36 arranged at a distance from one another, to which one of the ventilation nozzles 28 is connected, in each instance. Each ceiling wall 32 furthermore has a filling opening 38 arranged at a distance from the evacuation openings 36 and in the center between them, to which the filling nozzle 30 is connected.

Before the cavity 24 is filled with heat-conductive paste, it is evacuated by way of the evacuation openings 36, wherein the through-flow measurement device determines the amount of evacuated air. A pressure measurement device furthermore measures the pressure prevailing in the cavity, and the volume of the cavity 24 is calculated, by means of a data processing device, from the amount of air measured by the through-flow measurement device, the pressure prevailing in the cavity 24 before the start of evacuation, and the pressure prevailing in the cavity 24 after completion of evacuation. Subsequently, the heat-conductive paste is introduced into the cavity by means of the metering device 34, by way of the filling nozzle 30 and the filling opening 38; the volume of the paste corresponds to the volume of the cavity 24 as determined by the data processing device. In this regard, the pressure measurement device is arranged in the metering device 34 or in the filling nozzle 30, and is able to detect if a predetermined reference pressure has been exceeded, which pressure makes it necessary to stop filling the cavity 24. During the introduction of the heat-conductive paste, the vacuum in the cavity 24 is maintained. In order to prevent the heat-conductive paste from exiting through the evacuation openings 36, these are closed off, in each instance, by means of an air-permeable covering element, the permeability of which for the heat-conductive paste is clearly lower than its permeability for air. The filling opening 38 is furthermore provided with a sealing element that opens if an excess pressure is applied from the outside, so that the heat-conductive paste can be introduced into the cavity 24 under pressure, but closes when an excess pressure prevails in the cavity 24, so that the heat-conductive paste cannot exit through the filling opening 38 again when the filling nozzle 30 is removed from the filling opening 38.

In the present exemplary embodiment, two evacuation openings 36 and two ventilation nozzles 28 as well as one filling opening 38 and one filling nozzle 30 are provided. It is, of course, understood that, in particular as a function of the geometry of the battery trays 14, a different number of evacuation openings 36 and ventilation nozzles 28 as well as a different number of filling openings 38 and filling nozzles 30 can be provided.

In summary, the following should be stated: The invention relates to a method for filling a cavity 24, in particular a cavity 24 in a battery arrangement 12 that has a battery tray 14 and a battery 16 accommodated in the battery tray 14, with a viscous material, in particular with a heat-conductive paste.

According to the invention, it is provided that the cavity 24 is evacuated before the introduction of the viscous material.

1. A method for filling a cavity (24), in particular a cavity (24) in a battery arrangement (12) that has a battery tray (14) and a battery (16) accommodated in the battery tray (14), with a viscous material, in particular with a heat-conductive paste, wherein the cavity (24) is evacuated before the introduction of the viscous material.

2. The method according to claim 1, wherein the evacuation of the cavity (24) takes place at at least one evacuation opening (36).

3. Method The method according to claim 2, characterized in that wherein each evacuation opening (36) is closed off by means of an air-permeable covering element.

4. The method according to claim 3, wherein the at least one covering element is produced from a nonwoven fabric or from a selectively permeable membrane.

5. The method according to claim 4, wherein the at least one covering element has a thickness of at least 0.5 mm and at most 3 mm, and preferably of 1 mm to 2 mm.

6. The method according to claim 3, wherein the at least one covering element is adapted to the viscous material in such a manner that the at least one covering element has a selective permeability for the viscous material that amounts to at most 1/20 of the permeability for air.

7. The method according to claim 1, wherein the introduction of the viscous material takes place at at least one filling opening (38).

8. The method according to claim 7, wherein each filling opening (38) is arranged at a distance from each of the evacuation openings (36).

9. The method according to claim 7, wherein a sealing element is arranged at every filling opening (38), which element opens into the cavity (24) if an excess pressure is present outside of the cavity (24), and closes if an excess pressure is present in the cavity (24).

10. The method according to claim 9, wherein the at least one sealing element has a slit plastic film.

11. The method according to claim 1, wherein the vacuum in the cavity (24) is maintained until the end of the introduction of the viscous material.

12. The method according to claim 1, wherein the amount of air evacuated from the cavity (24) is measured, and wherein the volume of the cavity (24) is calculated from it.

13. The method according to claim 12, wherein an amount of viscous material is introduced into the cavity (24), the volume of which material corresponds to the calculated volume of the cavity (24).

14. The method according to claim 12, wherein the amount of air evacuated from the cavity (24) is determined by means of a through-flow measurement device or a piston metering device.

15. The method according to 12, wherein the pressure prevailing in the cavity (24) is measured, and wherein at least the pressure in the evacuated cavity (24) is used to calculate the volume of the cavity (24).

16. The method according to claim 1, wherein the pressure in the cavity (24) is measured by means of a pressure sensor arranged in a feed line for the viscous material, and wherein the introduction of the viscous material is stopped if the measured pressure exceeds a predetermined reference value.
